(19) United States
(12) Patent Application Publication
(10) Pub. No.: US 2013/0159490 A1
(43) Pub. Date: Jun. 20, 2013

(54) METHOD AND APPARATUS FOR SMART HOME SERVICE BASED ON CLOUD

(71) Applicant: INTELLECTUAL DISCOVERY CO., LTD., Seoul (KR)

(72) Inventors: Eui Nam Huh, Yongin-si (KR); Ga Won Lee, Uijeongbu-si (KR); Sung Woo Kim, Yongin-si (KR); Chang Woo Yoon, Daejeon (KR)

(73) Assignee: INTELLECTUAL DISCOVERY CO., LTD., Seoul (KR)

(21) Appl. No.: 13/666,865

(22) Filed: Nov. 1, 2012

(30) Foreign Application Priority Data
Dec. 16, 2011 (KR) 10-2011-0136321
Feb. 10, 2012 (KR) 10-2012-0013959

(51) Int. Cl. H04L 12/24

(52) U.S. Cl. CPC H04L 41/50
USPC 709/223

(57) ABSTRACT

Provided is a method and apparatus for a smart home service to which a virtual home gateway is applied. A server may generate a virtual smart home service apparatus through a virtualization technology, and the virtual smart home service apparatus and a gateway may divide and thereby perform a function of an existing gateway. A first terminal, the server, and the gateway may be connected to each other over a first network such as the Internet, and the gateway and a second terminal may be connected to each other over a second network such as a home network. The gateway may relay transmission and reception of data between the first network and the second network.

### TECHNICAL FIELD

The following embodiments relate to a method and apparatus for a smart home service, and more particularly, to a method and apparatus for a smart home service to which a virtual home gateway is applied.

### BACKGROUND ART

“Connected home” indicates that a variety of in-house apparatuses equipped with a network function, including electronic products, are connected to each other. “Connected home” has been gradually expanded all over the world.

Communication providers, electronic product manufacturers, Internet portals, and the like provide a connected service, such as application interaction or content interaction between connected apparatuses, for example. The above companies are recruiting customers of the service and are trying to increase revenues obtained from the service. For example, in European Countries, a gateway combined with an Internet protocol television (IPTV), a voice over Internet protocol (VoIP), and the like, has been placed on a large scale.

A gateway is an apparatus that functions as a bridge positioned between an external network and a home network to thereby connect the external network and the home network. The external network may be an Internet network or a wideband communication network. The home network may be a network constructed at home.

Gateway technology has started at a level of providing an Internet sharing function. In the gateway technology, a function of directly providing a media service, a home automatic service, and the like, or a function that enables such services to be readily provided from other apparatuses may be gradually added.

“Smart home” indicates an intelligent in-house living environment or an intelligent residential space. “Smart home” is in pursuit of an intelligent living environment, an environment-friendly residential life, and innovation of quality of life by realizing a ubiquitous environment at home based on wired/wireless communication and digital information appliances. The ubiquitous environment indicates an environment in which computing is provided without restrictions on a time, an occasion, and a device, by employing home networking and Internet information home appliances.

“Home automation” may indicate automation of house life and housekeeping life. Also, a home automation system may indicate a system to automate management of housekeeping work. The management of housekeeping work may be automated based on an electronic device, an automatic device, and the like. A home automation service may include controlling and monitoring an in-house device, managing a user and a terminal, and the like.

Cloud computing is a computing style that provides functions associated with information technology (IT) in a service form. An existing computing environment depends on independent hardware performance of each terminal. In a cloud computing environment, resources of computers present at physically different positions may be integrated through virtualization technology and the integrated resource may be provided.

A home gateway is an apparatus that functions as a bridge positioned between an external network and a home network to thereby connect the external network and the home network. The external network may be an Internet network or a wideband communication network. The home network may be a network constructed at home. A plurality of terminals may be present in the home network.

In a general home gateway, following issues may arise.

For example, a gateway is equipped with all of the communication protocols and thus, every time a new protocol is added to a home gateway, every time a function of a protocol installed in the home gateway is modified or changed, or every time firmware of the home gateway needs to be changed, the home gateway needs to be updated. Since the home gateway is installed at home, an operator may need to visit in person a user's house in which the home gateway is installed and to process an operation in order to update the home gateway or to add a terminal.

Also, all of the home automation services are performed through the home gateway. Accordingly, when a variety of error situations occur, countermeasures for the corresponding error situations need to be performed through the home gateway. Also, when an error situation occurs in the home gateway, it may be difficult to cope with the error situation. Since the home gateway manages and controls all of the in-house terminals, great load may be applied to the home gateway. Accordingly, managing and controlling of a terminal may be constrained based on performance of the home gateway.

All of the data associated with an operation of the home gateway is stored and processed within a database or a storage of the home gateway. Accordingly, due to limited capacity of the home gateway, it may become difficult to process a large amount of data.

With a variety of home automation services or commercialization of a smart home service, there is a need to apply technology about a virtual terminal and a virtual home gateway using cloud computing to the above services.

### DISCLOSURE OF INVENTION

### Technical Goals

An embodiment provides an apparatus and method that may provide a smart home service using cloud computing technology.

An embodiment provides a method that may manage and control a smart home service in a cloud computing environment.

### Technical Solutions

According to an aspect, there is provided a server, comprising: a processing unit to generate a virtual smart home service apparatus through a virtualization technology; and a networking unit to perform communication with a first terminal and a gateway, wherein the virtual smart home service apparatus receives a user request from the first terminal, converts a first protocol of the user request to a second protocol, and transmits the user request converted to the second protocol to the gateway, and the second protocol is a protocol capable of communicating with a second terminal connected to the gateway.

The virtual smart home service apparatus may receive information associated with the second terminal from the gateway, and may transmit information associated with the second terminal to the first terminal.

The virtual smart home service apparatus may generate metadata of information associated with the second terminal and may store information associated with the second terminal and the metadata.

The metadata may include attribute information used for searching for and mapping information associated with the second terminal.

When the user request is a request for searching for information stored within the virtual smart home service apparatus, the virtual smart home service apparatus may search for information corresponding to the user request using metadata of the stored information associated with the second terminal.

The user request may be a request for monitoring the second terminal in real time.

Information associated with the second terminal may be environment information and device information of the second terminal.

The environment information is information associated with an environment of the second terminal that is measured and collected from a neighboring environment of the second terminal.

The device information may be information associated with a current state of the second terminal.

The user request may be a request for controlling the second terminal.

Information associated with the second terminal may include a result of performing an operation of the second terminal in response to the control.

According to another aspect, there is provided a gateway, comprising: a data relay managing unit to relay transmission and reception of data between a first network and a second network, wherein the data relay managing unit receives a user request generated by a first terminal from a virtual smart home service apparatus that is connected over the first network, transmits the user request to a second terminal connected over the second network, receives information associated with the second terminal from the second terminal, and transmits information associated with the second terminal to the virtual smart home service apparatus, the virtual smart home service apparatus is generated through a virtualization technology of a server, and the first network and the second network are different from each other.

The gateway may further include an apparatus change sensing unit to sense a new terminal that is added within the second network.

The apparatus change sensing unit may sense a connection of the second terminal added within the second network, may collect information associated with the second terminal, and may transmit information associated with the second terminal to the virtual smart home service apparatus.

The gateway may further include a dangerous situation controlling unit to detect occurrence of a communication error between the virtual smart home service apparatus and the gateway.

The dangerous situation controlling unit may transmit a communication error signal indicating the communication error to the first terminal and may control the second terminal.

The gateway may further include a dangerous situation controlling unit.

Information associated with the second terminal may include environment information.

The environment information may be information associated with an environment of the second terminal that is measured and collected from a neighboring environment of the second terminal.

When the environment information has an abnormal value, the dangerous situation controlling unit may detect occurrence of a dangerous situation and may transmit a danger signal indicating the dangerous situation to the first terminal.

According to still another aspect, there is provided a method of providing a smart home service in a virtual smart home service apparatus generated through a virtualization technology of a server, the method comprising: receiving a user request from a first terminal; converting a first protocol of the user request to a second protocol; and transmitting the user request converted to the second protocol to a gateway, wherein the second protocol is a protocol capable of communicating with a second terminal connected to the gateway.

The smart home service providing method may further include: receiving information associated with the second terminal from the gateway; and transmitting information associated with the second terminal to the first terminal.

The smart home service providing method may further include generating metadata of information associated with the second terminal and storing information associated with the second terminal and the metadata.

The smart home service providing method may further include searching for information corresponding to the user request using metadata of information associated with the second terminal when the user request is a request for searching for information stored within the virtual smart home service apparatus.

According to yet another aspect, there is provided a method of providing a smart home service in a gateway relaying transmission and reception of data between a first network and a second network, the method comprising: receiving a user request generated by a first terminal from a virtual smart home service apparatus that is connected over the first network; transmitting the user request to a second terminal connected over the second network; receiving information associated with the second terminal from the second terminal; and transmitting information associated with the second terminal to the virtual smart home service apparatus, wherein the virtual smart home service apparatus is generated through a virtualization technology of a server, and the first network and the second network are different from each other.

The smart home service providing method may further include: sensing a connection of the second terminal that is added within the second network; collecting information associated with the second terminal; and transmitting information associated with the second terminal to the virtual smart home service apparatus.

The smart home service providing method may further include: detecting occurrence of a communication error between the virtual smart home service apparatus and the gateway; transmitting a communication error signal indicating the communication error to the first terminal; and controlling the second terminal.

The smart home service providing method may further include: detecting occurrence of a dangerous situation when the environment information has an abnormal value; and transmitting a danger signal indicating the dangerous situation to the first terminal.

### Effect of the Invention

According to embodiments, a cloud server may manage, maintain, and repair terminals in a home network through a virtual smart home service apparatus using a cloud computing environment.

According to embodiment, a virtual smart home service apparatus generated by a server may be allotted with a portion of functions performed by an existing home gateway. Through the above allotment, a weight-reduced gateway may be constructed.

According to embodiments, a large amount of data associated with a home network may be processed using a storage unit of a virtual smart home service apparatus. Also, in the case of upgrading, maintaining, and repairing terminals in the home network, substantial works may be processed within the virtual smart home service apparatus.

According to embodiments, when providing a smart home service through a virtual smart home service apparatus, load applied to a gateway may decrease. Also, a smart home service independent from the gateway may be provided through the virtual smart home service apparatus.

According to embodiments, a virtual smart home service apparatus may notify a user about occurrence of a dangerous situation or an error when the dangerous situation occurs in a house or when the error occurs in a home network.

According to embodiments, a smart home service system using a virtual smart home service apparatus may be utilized for a conventional home automation system and smart home service. Also, the smart home service system using a virtual home gateway may be applied to a variety of fields that require an automation system, such as a smart office, a smart school, a smart hospital, and the like, for example.

### BRIEF DESCRIPTION OF DRAWINGS

FIG. 1 is a diagram illustrating a structure of a smart home service system based on cloud computing according to an embodiment;

FIG. 2 is a block diagram illustrating a configuration of a server according to an embodiment;

FIG. 3 is a block diagram illustrating a configuration of a virtual smart home service apparatus according to an embodiment;

FIG. 4 is a block diagram illustrating a configuration of a gateway according to an embodiment;

FIG. 5 is a block diagram illustrating a configuration of a gateway according to an embodiment;

FIG. 6 is a flowchart illustrating a method of providing a smart home service according an embodiment;

FIG. 7 is a flowchart illustrating a method of providing a smart home service in a case in which a dangerous situation occurs according to an embodiment;

FIG. 8 is a flowchart illustrating a method of providing a smart home service in a case in which a communication error occurs according to an embodiment; and

FIG. 9 is a flowchart illustrating a method of providing a smart home service in a case in which a second terminal is added according to an embodiment.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

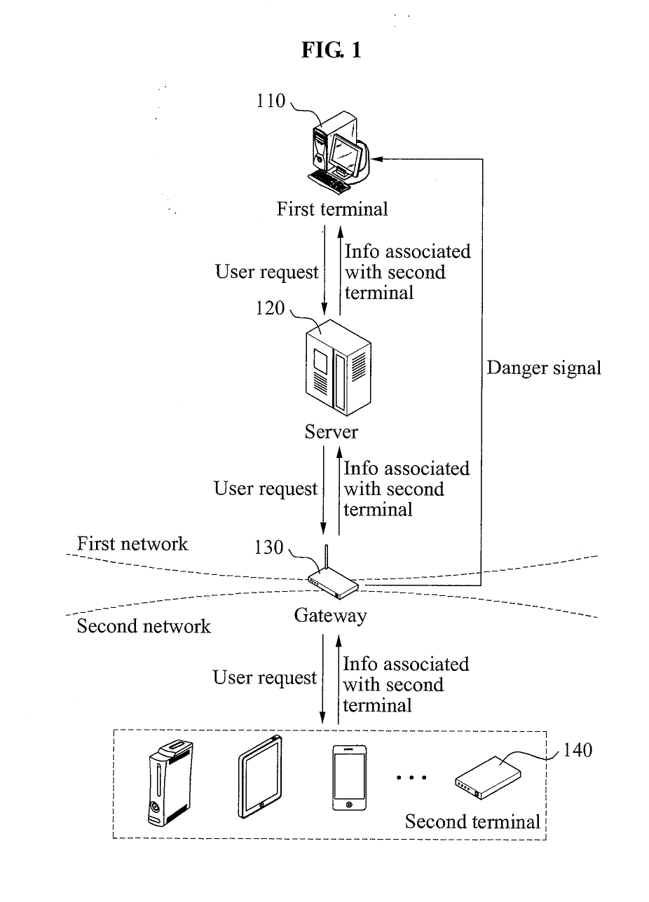

FIG. 1 is a diagram illustrating a structure of a smart home service system based on a cloud computing according to an embodiment.

The smart home service system may include a first terminal, a server 120, a gateway 130, and a second terminal 140.

The first terminal 110 may be a terminal that is used by a user of the smart home service system. The first terminal 110 may be a terminal used to access the server 120.

The server 120 may be a cloud computing server. The server 120 may be one of servers included in a cloud computing server set.

The gateway 130 may be a home gateway or a wireless router.

The second terminal 140 may be an Internet information device. At least one second terminal 140 may be present.

The first terminal 110, the server 120, and the gateway 130 may be connected to each other over a network such as the Internet. Hereinafter, the network connecting the first terminal 110 and the server 120 is referred to as a first network.

The gateway 130 and the second terminal 140 may be connected to each other over a network. Hereinafter, the network connecting the gateway 130 and the second terminal 140 is referred to as a second network. The second network may be a home network. The first network and the second network may be different from each other.

The gateway 130 may be connected to the server 120 over the first network, and may be connected to the second terminal 140 over the second network. The gateway 130 may function as a relay between the first terminal 110 and the server 120, and between the server 120 and the second terminal 140 over the first network and the second network, respectively. The gateway 130 may be positioned within a house. In the house, the gateway 130 may connect at least one second terminal through the second network.

A user request generated by the first terminal 110 may be transferred to the second terminal 140 through the server 120 and the gateway 130. Information associated with the second terminal 140 that is generated by the second terminal 140 may be transferred to the first terminal 110 through the gateway 130 and the server 120. When a dangerous situation occurs, the gateway 130 may transmit a danger signal indicating the dangerous situation to the first terminal 110. For example, the server 120 and the gateway 130 may perform a relaying function between the first terminal 110 and the second terminal 140.

The gateway 130 may sense a new second terminal 140 that is added within the second network. The gateway 130 may transmit, to the server 120, information associated with the sensed new second terminal 140. A virtual smart home service apparatus 300 may store information associated with the new second terminal 140. The gateway 130 or the server 120 may transmit information associated with the new second terminal 140 to the first terminal 110.

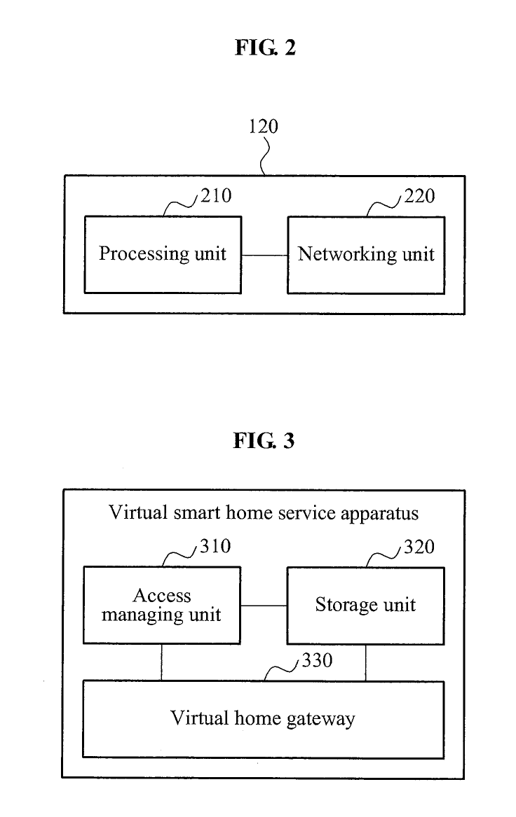

FIG. 2 is a block diagram illustrating a configuration of a server according to an embodiment.

The server 120 may include a processing unit 210 and a networking unit 220.

The processing unit 210 may be at least one processor or at least one core within a processor. The processing unit 210 may perform an operation required for an operation of the server 120. Here, performing an operation may indicate executing a program code.

The networking unit 220 may be a hardware module, such as a network interface card, a network interface chip, and a network interface port, for example, and may be a software module, such as a network device driver and a networking program, for example.

The networking unit 220 may perform communication within the first network. The communication may include transmission and reception of data. The networking unit 220 may communicate with the first terminal 110 and the gateway 130.

FIG. 3 is a block diagram illustrating a configuration of a virtual smart home service apparatus according to an embodiment.

The processing unit 210 may generate the virtual smart home service apparatus 300 through virtualization technology.

The virtual smart home service apparatus 300 may perform a portion of functions provided by a conventional gateway. The virtual smart home service apparatus 300 and the gateway 130 may divide and thereby provide functions provided by the conventional gateway. For example, the virtual smart home service apparatus 300 may transmit a user request transmitted from the first terminal 110, to the gateway 130 using a protocol that may be used by the second terminal 140. The virtual smart home service apparatus 300 may store information associated with the second terminal 140 transmitted from the gateway 130, and may transmit information associated with the second terminal 140 to the first terminal 110.

The user request may indicate a request for monitoring the second terminal 140 in real time, a request for controlling the second terminal 140, or a request for searching for information associated with the second terminal 140 that is stored in the virtual smart home service apparatus 300.

The first terminal 110 and the virtual smart home service apparatus 300 may use a transmission control protocol/Internet protocol (TCP/IP) to operate in an Internet environment. At least two second terminals present in a house may use a variety of protocols associated with usages, purposes, or features of second terminals. Accordingly, protocol integration may be required for communication between the virtual smart home service apparatus 300 and the second terminal 140. The virtual smart home service apparatus 300 may perform communication between the virtual smart home service apparatus 300 and the second terminal 140 through a protocol conversion.

The processing unit 210 may allocate the generated virtual smart home service apparatus 300 to the user or the first terminal 110. The server 120 may assign a right to access the virtual smart home service apparatus 300 to the user or the first terminal 110.

The virtual smart home service apparatus 300 may include an access managing unit 310, a virtual home gateway 330, and a storage unit 320.

Each of the virtual smart home service apparatus 300, the access managing unit 310, the virtual home gateway 330, and the storage unit 320 may be a program code executed by the processing unit 210. Accordingly, operations of the virtual smart home service apparatus 300 that are described to be performed by the access managing unit 310, the virtual home gateway 330, and the storage unit 320 may be performed by the processing unit 210 and the networking unit 220. Among the operations of the virtual smart home service apparatus 300 that are described to be performed by the access managing unit 310, the virtual home gateway 330, and the storage unit 320, an operation associated with processing of data may be performed by the processing unit 210 and an operation associated with transmission and reception of data may be performed by the networking unit 220.

The access managing unit 310 may manage an access of the first terminal 110 to enable the first terminal 140 to access the virtual smart home service apparatus 300 in order to use a virtual smart home service.

The storage unit 320 may be a database. The storage unit 320 may store information associated with the second terminal 140. The storage unit 320 may store metadata of information associated with the second terminal 140. In response to a request of the virtual home gateway 330, the storage unit 320 may provide the stored metadata and information associated with the second terminal 140 to the virtual home gateway 330.

The virtual home gateway 330 may be equipped with a variety of communication protocols. Using the equipped communication protocols, the virtual home gateway 330 may convert a protocol corresponding to a user request that is transmitted from the first terminal 110 and a protocol of information associated with the second terminal 140 that is transmitted from the gateway 130. Through the above conversion, the virtual home gateway 330 enables communication between the first terminal 110 and the second terminal 140, and enables communication between the first terminal 110 and the gateway 130.

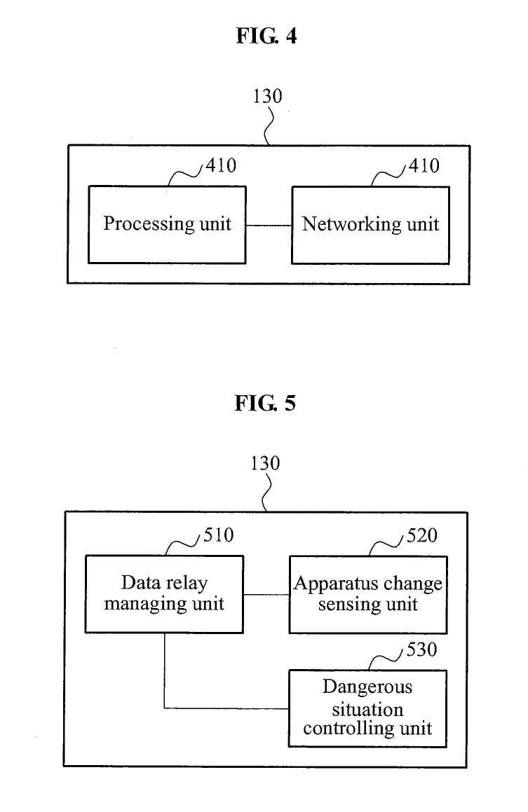

FIG. 4 is a block diagram illustrating a configuration of a gateway according to an embodiment.

The gateway 130 may include a processing unit 410 and a networking unit 420.

The processing unit 410 may be at least one processor or at least one core within a processor. The processing unit 410 may perform an operation required for an operation of the gateway 130. Here, performing an operation may indicate executing a program code.

The networking unit 420 may be a hardware module, such as a network interface card, a network interface chip, and a network interface port, for example, and may be a software module, such as a network device driver and a networking program, for example.

The networking unit 420 may perform communication within the first network. The communication may include transmission and reception of data.

FIG. 5 is a block diagram illustrating a configuration of a gateway according to an embodiment.

The gateway 130 may include a data relay managing unit 510, an apparatus change sensing unit 520, and a dangerous situation controlling unit 530. Alternatively, the processing unit 410 of the gateway 130 may execute the data relay managing unit 510, the apparatus change sensing unit 520, and the dangerous situation controlling unit 530.

Each of the data relay managing unit 510, the apparatus change sensing unit 520, and the dangerous situation controlling unit 530 may be a program code that is executed by the processing unit 410. Accordingly, operations of the gateway 130 that are described to be performed by the data relay managing unit 510, the apparatus change sensing unit 520, and the dangerous situation controlling unit 530 may be performed by the processing unit 410 and the networking unit 420. Among the operations of the gateway 130 that are described to be performed by the data relay managing unit 510, the apparatus change sensing unit 520, and the dangerous situation controlling unit 530, an operation associated with processing of data may be performed by the processing unit 410 and an operation associated with transmission and reception of data may be performed by the networking unit 420.

The data relay managing unit 510 may relay transmission and reception of data between the virtual smart home service apparatus 300 and the second terminal 140. For example, the data relay managing unit 510 may transmit, to the second terminal 140, a user request transmitted from the virtual smart home service apparatus 300. The data relay managing unit 510 may transmit, to the virtual smart home service apparatus 300, information associated with the second terminal 140 that is transmitted from the second terminal 140.

When a new second terminal 140 is added within the second network, the apparatus change sensing unit 520 may sense addition of the new second terminal 140. The apparatus change sensing unit 520 may receive information associated with the added new second terminal 140 from the added new second terminal 140. The apparatus change sensing unit 520 may transmit the received information associated with the added new second terminal 140 to the virtual smart home service apparatus 300.

The dangerous situation controlling unit 530 may detect occurrence of a dangerous situation. The dangerous situation may occur in a house in which the second terminal 140 is installed. When the dangerous situation occurs, the dangerous situation controlling unit 530 may notify the first terminal 110 about the occurrence of the dangerous situation and may take countermeasures for the dangerous situation.

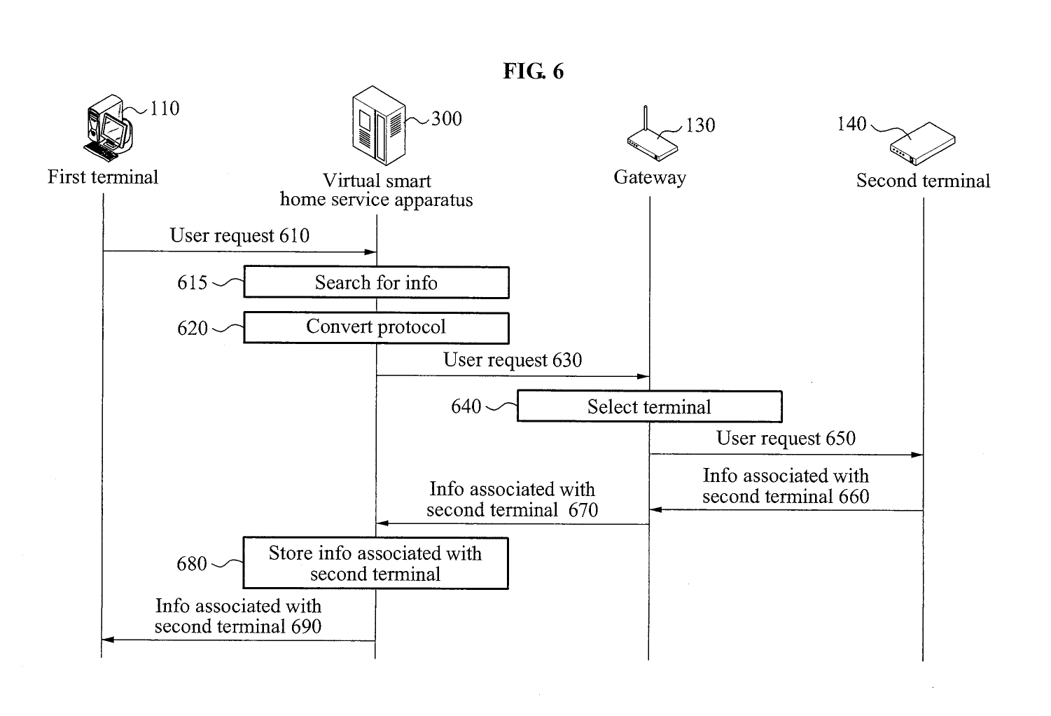

FIG. 6 is a flowchart illustrating a method of providing a smart home service according an embodiment.

The smart home service providing method may be performed by the gateway 130 and the virtual smart home service apparatus 300 generated through virtualization technology of the server 120.

In operation 610, the first terminal 110 may transmit a user request to the access managing unit 310 of the virtual smart home service apparatus 300. The access managing unit 310 may receive the user request from the first terminal 110. The user request may be generated by the first terminal 110.

The user request may be a request for monitoring the second terminal 140 in real time, a request for controlling the second terminal 140, or a request for searching for information associated with the second terminal 140. Information associated with the second terminal 140 may be information stored in the storage unit 320 of the virtual smart home service apparatus 300.

When the user request is a request for searching for information stored in the virtual smart home service apparatus 300, operation 615 may be performed. The stored information may be information associated with the second terminal 140.

In operation 615, the virtual home gateway 330 may search for information corresponding to the user request using metadata of information associated with the second terminal 140 that is stored in the storage unit 320. The found information may be transmitted to the first terminal 110 as information associated with the second terminal 140 in operation 690.

When operation 615 is performed, there is no need to transfer the user request to the gateway 130 or to transmit information associated with the second terminal 140 from the gateway 130 to the virtual smart home service apparatus 300. Accordingly, the following operations 620 through 680 may be omitted.

In operation 620, the virtual home gateway 330 of the virtual smart home service apparatus 300 may convert a first protocol of the received user request to a second protocol. The second protocol is a protocol capable of communicating with the second terminal 140.

The first protocol may be a protocol that is used in a first network. The second protocol may be a protocol that is used in a second network. The first protocol may be a general Internet protocol. For example, the first protocol may be a TCP/IP. The second protocol may be a variety of wired/wireless protocols that are selected based on a usage, a feature, or a performance of the second terminal 140. For example, the second protocol may be at least one of a TCP/IP, wireless-fidelity (Wi-Fi), a programmable logic controller (PLC), and ZigBee. The server 120 or the virtual smart home service apparatus 300 may perform conversion between protocols by being equipped with the first protocol and the second protocol.

In operation 630, the virtual home gateway 330 may transmit the user request to the data relay managing unit 510 of the gateway 130. The user request may be the user request that is converted to the second protocol.

The virtual smart home service apparatus 300 may relay the user request by transmitting the user request transmitted from the first terminal 110 to the gateway 130.

The data relay managing unit 510 may receive the user request from the virtual home gateway 330.

In operation 640, the data relay managing unit 510 may select a terminal to transmit the user request from among one or more second terminals. The selected terminal may be a terminal indicated by the user request among the one or more second terminals. In FIG. 6, the second terminal 140 is illustrated as the selected terminal. For example, the data relay managing unit 510 may select the second terminal 140 as the terminal to transmit the user request from among the one or more terminals present within the second terminal.

In operation 650, the data relay managing unit 510 may transmit the user request to the second terminal 140.

In operation 660, the second terminal 140 may transmit information associated with the second terminal 140 to the data relay managing unit 510 in response to the transmitted user request.

Information associated with the second terminal may be information corresponding to the user request.

For example, when the user request is a request for monitoring the second terminal 140 in real time, information associated with the second terminal 140 may be environment information and device information of the second terminal 140.

The environment information may be information associated with an environment of the second terminal 140 that is measured and collected from a neighboring environment of the second terminal 140. The environment information may include information associated with a temperature, intensity of illumination, humidity, an air state, and the like. The environment information may include a variety of in-house state information such as an image of a visitor, an internal image, and a missed call, for example. Absence/presence of a person may indicate whether a person is present within a predetermined range from the second terminal 140 or whether a person who controls the second terminal 140 is present. The second terminal 140 may obtain environment information using various types of sensors included in the second terminal 140.

The device information may include information associated with a current state of the second terminal 140. The device information may include information associated with a type, a performance, a position, an operational state, and a setting state of the second terminal 140. The device information may include an identifier (ID) assigned by the virtual smart home service apparatus 300 to the second terminal 140.

For example, when the user request is a request for controlling the second terminal 140, the second terminal 140 may operate in response to a control indicated by the user request. Information associated with the second terminal 140 may include a result of performing the above operation.

The data relay managing unit 510 may receive information associated with the second terminal 140 from the second terminal 140.

In operation 670, the data relay managing unit 510 may transmit information associated with the second terminal 140 to the virtual home gateway 330.

The virtual home gateway 330 may receive information associated with the second terminal 140 from the data relay managing unit 510.

In operation 680, the virtual home gateway 330 may store information associated with the second terminal 140 in the storage unit 320.

The virtual home gateway 330 may generate metadata of information associated with the second terminal 140 based on information associated with the second terminal 140. The metadata may include attribute information. The attribute information may be used for searching for and mapping information associated with the second terminal 140.

The virtual home gateway 330 may store metadata of information associated with the second terminal 140 in the storage unit 320.

In operation 690, the access managing unit 310 may transmit information associated with the second terminal 140 to the first terminal 110.

The aforementioned operations 630 through 690 may be periodically performed. The virtual smart home service apparatus 300 may periodically update information associated with the second terminal 140.

The user request transmitted in operation 610 may be a request for periodically transmitting information associated with the second terminal 140. For example, the first terminal 110 may request the virtual smart home service apparatus 300 to periodically transmit information associated with the second terminal 140.

When the user desires information associated with the second terminal 140 to be periodically stored, operation 630 may be periodically repeated. For example, by periodically repeating operation 630, the virtual home gateway 330 may periodically transmit the user request to the data relay managing unit 510 of the gateway 130. By periodically repeating operation 650, the data relay managing unit 510 may periodically transmit the user request to the second terminal 140. By periodically repeating operation 660, the second terminal 140 may periodically transmit information associated with the second terminal 140 to the data relay managing unit 510 in response to the transmitted user request.

Information associated with the second terminal 140 periodically transmitted may be stored in the storage unit 320. When the user request is a request for searching for information associated with the second terminal 140, the virtual home gateway 330 may select information corresponding to the user request from information associated with the second terminal 140, using metadata of the stored information associated with the second terminal 140.

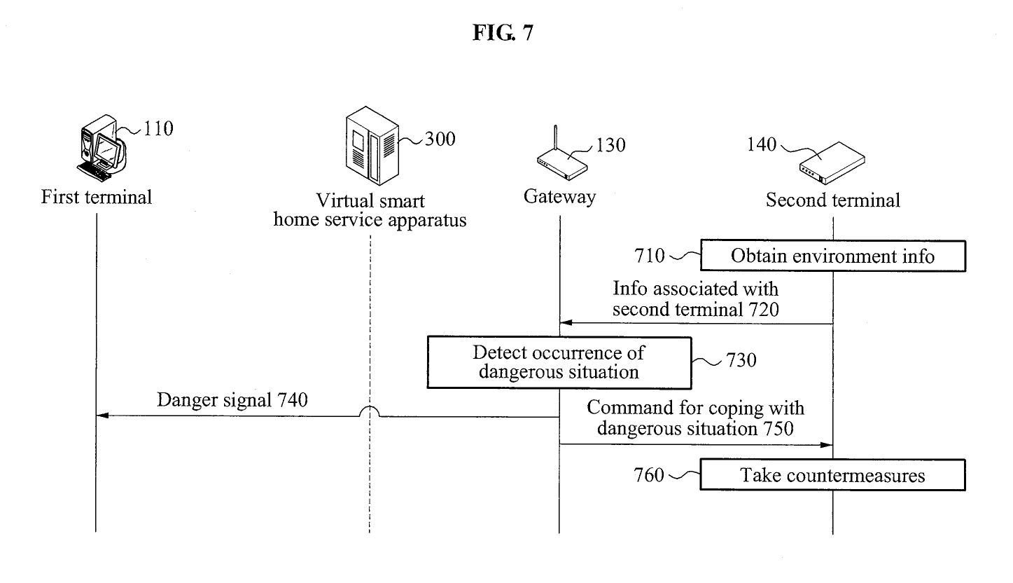

FIG. 7 is a flowchart illustrating a method of providing a smart home service in a case in which a dangerous situation occurs according to an embodiment.

In operation 710, the second terminal 140 may obtain environment information using a variety of sensors provided in the second terminal 140. For example, when the second terminal 140 is an electronic home appliance for Internet information associated with air conditioning or heating, the second terminal 140 may measure an indoor temperature or an outdoor temperature. When the second terminal 140 is an air cleaner, the second terminal 140 may measure an air state. The second terminal 140 may measure a variety of information, such as access of a person, gas leakage, and the like, for example.

In operation 720, the second terminal 140 may transmit information associated with the second terminal 140 to the data relay managing unit 510 in response to the transmitted user request. Information associated with the second terminal 140 may include environment information. Operation 720 may correspond to operation 660 of FIG. 6.

In operation 730, the dangerous situation controlling unit 530 of the gateway 130 may compare environment information with a threshold. When environment information has a value within an abnormal range, the dangerous situation controlling unit 530 may detect occurrence of the dangerous situation. The dangerous situation controlling unit 530 may determine whether the environment information has an abnormal value by comparing a measurement value included in environment information with a predetermined threshold. The predetermined threshold may be a value set by a user of the second terminal 140 or a manufacturer of the second terminal 140. The predetermined threshold may be a value used as a criterion to determine occurrence of the dangerous situation through comparison with the measurement value included in environment information.

For example, in a case in which the second terminal 140 is an electronic appliance for Internet information associated with air conditioning or heating, the dangerous situation controlling unit 530 may detect occurrence of fire when an indoor temperature measured by the second terminal 140 exceeds a predetermined threshold, for example, 100 degrees.

When the dangerous situation occurs, communication between the virtual smart home service apparatus 300 and the gateway 130 may not be guaranteed. Accordingly, when the dangerous situation occurs, existing communication between the virtual smart home service apparatus 300 and the gateway 130 and communication between the first terminal 110 and the gateway 130 may be required. For example, the gateway 130 may need to autonomously transmit a danger signal to the first terminal 110.

In operation 740, the dangerous situation controlling unit 530 may transmit a danger signal indicating the dangerous situation to the first terminal 110.

In operation 750, the dangerous situation controlling unit 530 may transmit a command for coping with the dangerous situation to the second terminal 140. The command for coping with the dangerous situation may be a command pre-stored in the dangerous situation controlling unit 530.

In operation 760, the second terminal 140 may perform countermeasures in response to the command for coping with the dangerous situation.

Operations 710 through 760 may be added to operations 610 through 690 of FIG. 6 and thereby, be performed.

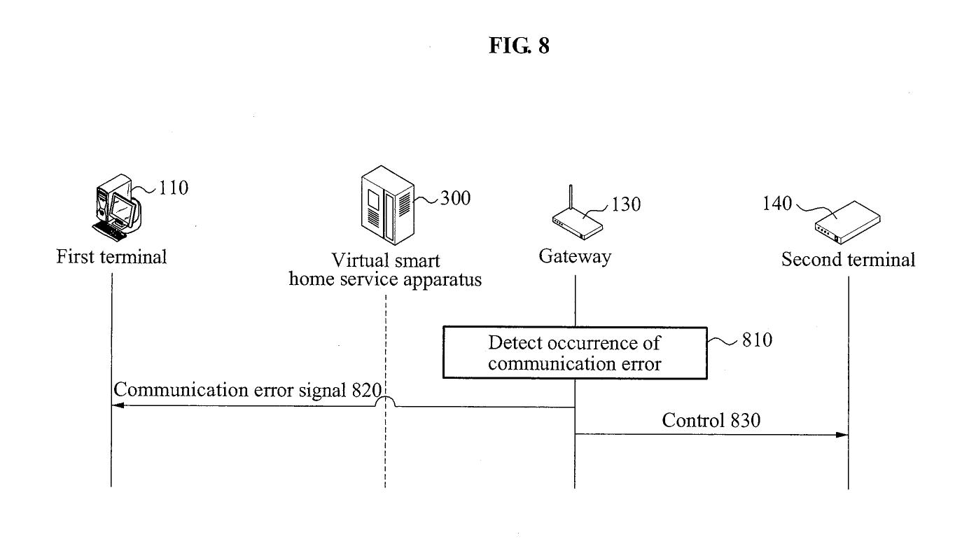

FIG. 8 is a flowchart illustrating a method of providing a smart home service in a case in which a communication error occurs according to an embodiment.

In operation 810, the dangerous situation controlling unit 530 of the gateway 130 may detect occurrence of a communication error. The communication error may indicate an error that occurs in communication between the virtual smart home service apparatus 300 and the gateway 130.

In operation 820, the dangerous situation controlling unit 530 may transmit a communication error signal indicating the communication error to the first terminal 110.

In operation 830, the dangerous situation controlling unit 530 may control the second terminal 140. Even though the communication error abruptly occurs, the first terminal 110 and the gateway 130 may perform a basic control and management with respect to the second terminal 140 through the above control.

The communication error may be regarded as one of the dangerous situations described above with reference to FIG. 7.

Operations 810 through 830 may be added to operations 610 through 690 of FIG. 6 and thereby, be performed.

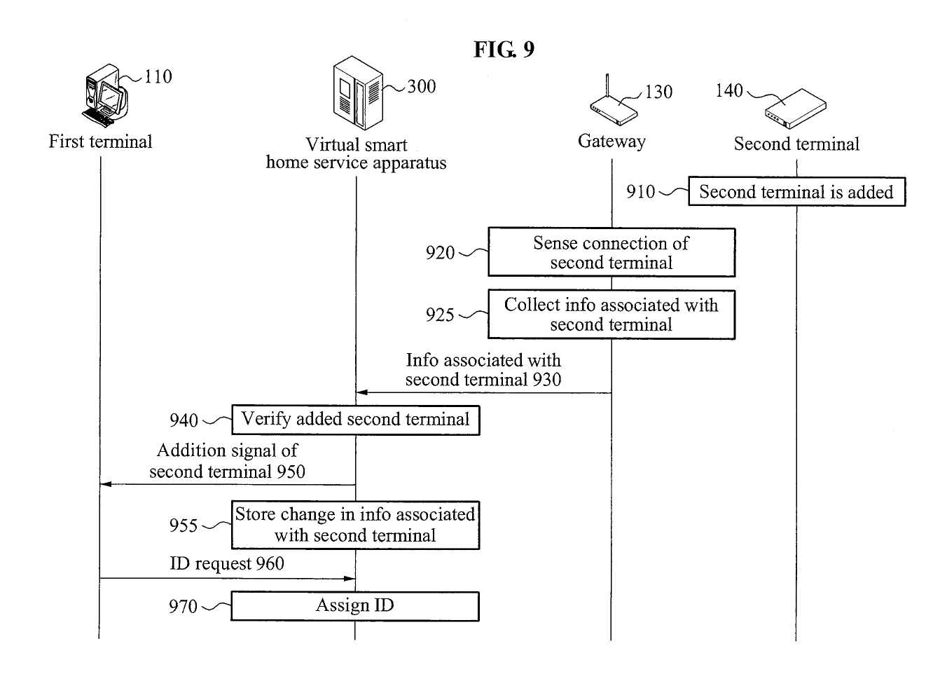

FIG. 9 is a flowchart illustrating a method of providing a smart home service in a case in which a second terminal is added according to an embodiment.

In operation 910, the second terminal 140 may be added within the second network. The added second terminal 140 may be connected to the gateway 130.

In operation 920, the apparatus change sensing unit 520 of the gateway 130 may automatically sense connection of the second terminal 140.

In operation 925, the apparatus change sensing unit 520 may collect information associated with the added second terminal 140.

In operation 930, the apparatus change sensing unit 520 may transmit information associated with the added second terminal 140 to the virtual home gateway 330 of the virtual smart home service apparatus 300. The virtual home gateway 330 may receive information associated with the added second terminal 140 from the apparatus change sensing unit 520.

In operation 940, the virtual home gateway 330 may verify the added second terminal 140 based on information associated with the added second terminal 140.

In operation 950, the virtual home gateway 330 may transmit an addition signal of the second terminal 140 to the first terminal 110.

In operation 955, the virtual home gateway 330 may store a change in information associated with the second terminal 140 in the storage unit 320.

In operation 960, the first terminal 110 may transmit a request for assigning an ID to the added second terminal 140 to the access managing unit 310.

In operation 970, the virtual home gateway 330 may assign an ID to the added second terminal 140.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The computer readable recording medium may include any data storage device that can store data which can be thereafter read by a computer system or processing device. Examples of the computer readable recording medium include read-only memory (ROM), random-access memory (RAM), CD-ROMs, magnetic tapes, floppy disks, optical data storage devices. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### Explanation of Symbols

110: first terminal

120: server

130: gateway

140: second terminal

300: virtual smart home service apparatus

1. A server, comprising:
a processing unit to generate a virtual smart home service apparatus through a virtualization technology; and
a networking unit to perform communication with a first terminal and a gateway,
wherein the virtual smart home service apparatus receives a user request from the first terminal, converts a first protocol of the user request to a second protocol, and transmits the user request converted to the second protocol to the gateway, and
the second protocol is a protocol capable of communicating with a second terminal connected to the gateway.

2. The server of claim 1, wherein the virtual smart home service apparatus receives information associated with the second terminal from the gateway, and transmits information associated with the second terminal to the first terminal.

3. The server of claim 1, wherein:
the virtual smart home service apparatus generates metadata of information associated with the second terminal and stores information associated with the second terminal and the metadata, and
the metadata comprises attribute information used for searching for and mapping information associated with the second terminal.

4. The server of claim 1, wherein when the user request is a request for searching for information stored within the virtual smart home service apparatus, the virtual smart home service apparatus searches for information corresponding to the user request using metadata of the stored information associated with the second terminal.

5. The server of claim 1, wherein:
the user request is a request for monitoring the second terminal in real time,
information associated with the second terminal is environment information and device information of the second terminal,
the environment information is information associated with an environment of the second terminal that is measured and collected from a neighboring environment of the second terminal, and
the device information is information associated with a current state of the second terminal.

6. The server of claim 1, wherein:
the user request is a request for controlling the second terminal, and
information associated with the second terminal comprises a result of performing an operation of the second terminal in response to the control.

7. A gateway, comprising:
a data relay managing unit to relay transmission and reception of data between a first network and a second network,
wherein the data relay managing unit receives a user request generated by a first terminal from a virtual smart home service apparatus that is connected over the first network, transmits the user request to a second terminal connected over the second network, receives information associated with the second terminal from the second terminal, and transmits information associated with the second terminal to the virtual smart home service apparatus,
the virtual smart home service apparatus is generated through a virtualization technology of a server, and
the first network and the second network are different from each other.

8. The gateway of claim 7, further comprising:
an apparatus change sensing unit to sense a new terminal that is added within the second network,
wherein the apparatus change sensing unit senses a connection of the second terminal added within the second network, collects information associated with the second terminal, and transmits information associated with the second terminal to the virtual smart home service apparatus.

9. The gateway of claim 7, further comprising:
a dangerous situation controlling unit to detect occurrence of a communication error between the virtual smart home service apparatus and the gateway,
wherein the dangerous situation controlling unit transmits a communication error signal indicating the communication error to the first terminal and controls the second terminal.

10. The gateway of claim 7, further comprising:
a dangerous situation controlling unit,
wherein information associated with the second terminal comprises environment information, and the environment information is information associated with an environment of the second terminal that is measured and collected from a neighboring environment of the second terminal, and
when the environment information has an abnormal value, the dangerous situation controlling unit detects occurrence of a dangerous situation and transmits a danger signal indicating the dangerous situation to the first terminal.

11. A method of providing a smart home service in a virtual smart home service apparatus generated through a virtualization technology of a server, the method comprising:
receiving a user request from a first terminal;
converting a first protocol of the user request to a second protocol; and
transmitting the user request converted to the second protocol to a gateway,
wherein the second protocol is a protocol capable of communicating with a second terminal connected to the gateway.

12. The method of claim 11, further comprising:
receiving information associated with the second terminal from the gateway; and
transmitting information associated with the second terminal to the first terminal.

13. The method of claim 11, further comprising:
generating metadata of information associated with the second terminal and storing information associated with the second terminal and the metadata,
wherein the metadata comprises attribute information used for searching for and mapping information associated with the second terminal.

14. The method of claim 11, further comprising:
searching for information corresponding to the user request using metadata of information associated with the second terminal when the user request is a request for searching for information stored within the virtual smart home service apparatus.

15. The method of claim 11, wherein:
the user request is a request for monitoring the second terminal in real time,
information associated with the second terminal is environment information and device information of the second terminal,
the environment information is information associated with an environment of the second terminal that is measured and collected from a neighboring environment of the second terminal, and
the device information is information associated with a current state of the second terminal.

16. The method of claim 11, wherein:
the user request is a request for controlling the second terminal, and
information associated with the second terminal comprises a result of performing an operation of the second terminal in response to the control.

17. A method of providing a smart home service in a gateway relaying transmission and reception of data between a first network and a second network, the method comprising:
receiving a user request generated by a first terminal from a virtual smart home service apparatus that is connected over the first network;
transmitting the user request to a second terminal connected over the second network;
receiving information associated with the second terminal from the second terminal; and
transmitting information associated with the second terminal to the virtual smart home service apparatus,
wherein the virtual smart home service apparatus is generated through a virtualization technology of a server, and the first network and the second network are different from each other.

18. The method of claim 17, further comprising:
sensing a connection of the second terminal that is added within the second network;
collecting information associated with the second terminal; and
transmitting information associated with the second terminal to the virtual smart home service apparatus.

19. The method of claim 17, further comprising:
detecting occurrence of a communication error between the virtual smart home service apparatus and the gateway;
transmitting a communication error signal indicating the communication error to the first terminal; and
controlling the second terminal.

20. The method of claim 17, further comprising:
detecting occurrence of a dangerous situation when the environment information has an abnormal value; and
transmitting a danger signal indicating the dangerous situation to the first terminal,
wherein information associated with the second terminal comprises environment information, and the environment information is information associated with an environment of the second terminal that is measured and collected from a neighboring environment of the second terminal.
